(19) United States
(12) Patent Application Publication
(10) Pub. No.: US 2009/0133393 A1
(43) Pub. Date: May 28, 2009

(54) METHOD FOR OPERATING A HYDROPNEUMATIC DEVICE, AND HYDRAULIC FLUID PUMP FOR THE MAINTENANCE OF A HYDROPNEUMATIC DEVICE

(75) Inventors: Bernd SCHAD, Ebersbach (DE); Georg GERNERT, Kisslegg (DE); Werner MOTZ, Kisslegg (DE); Eberhard DIETZEL, Weingarten (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: TOX PRESSOTECHNIK GMBH & CO. KG, Weingarten (DE)

(21) Appl. No.: 12/234,218

(22) Filed: Sep. 19, 2008

(30) Foreign Application Priority Data
Sep. 19, 2007 (DE) 10 2007 044 907.2

(51) Int. Cl. F15B 1/027

(52) U.S. Cl. 60/327; 60/325

(57) ABSTRACT

A method is disclosed for operating a hydropneumatic device (1) for pressure multiplication, with a working piston and a multiplier piston (9) for pressure multiplication on to the working piston and with an accumulator piston (3) for an urgent movement of the working piston by forcing hydraulic fluid out of an accumulator chamber (12), wherein a ventilation opening (13) is provided in the accumulator chamber (12), through which air drawn into the accumulator chamber (12) can be discharged during a maintenance process. According to the invention for an operating mode in which power strokes are executed, the hydraulic fluid volume in the accumulator chamber (12) is discharged below the ventilation opening (13) in the accumulator chamber. The hydraulic fluid pump is additionally disclosed.

### CROSS-REFERENCE TO RELATED APPLICATIONS

This application is the U.S. national phase of German Patent Application No. DE 10 2007 044 907.2 filed Sep. 19, 2007, the entire content of which is incorporated herein by reference.

### FIELD OF THE INVENTION

The invention relates to a method for operating a hydropneumatic device and to a hydraulic fluid pump used in performing such method.

### BACKGROUND OF THE INVENTION

Hydropneumatic devices for increasing pressure with a working piston and a multiplier piston, and an accumulator piston which acts on an accumulator chamber filled with hydraulic fluid, have already become known in a wide range of embodiments. The accumulator piston serves the purpose of pneumatically effecting an urgent movement of the working piston comparatively rapidly, by forcing hydraulic fluid out of the accumulator chamber. This allows a movement of the working piston to be rapidly bypassed, in which case the working piston does not require full power. The working piston is in fact, due to the urgent movement, displaced to a position in which a power stroke should take place. Thereafter, by means of the multiplier piston a pneumatic pressure increase can be applied into the hydraulic fluid, which causes the working piston to execute a motion with the full stroke force.

In hydropneumatic drive units, due to the adjacent location of pneumatic and hydraulic areas within the same housing, a gradual entry of small air bubbles from the pneumatic to the hydraulic region is a regular occurrence. For example, air is dragged into the accumulator chamber due to the motion of the accumulator piston. The air volume thereby accumulating in the accumulator chamber, due to the compressibility of the air, leads to a situation in which the high pressure required for building up a power stroke is only reached after the compression of the volume of air that has been drawn in. As a result, with an increasing amount of air taken into the hydraulic fluid, the originally defined piston stroke of the working piston is no longer available with the full power of the stroke.

The volume of air drawn in must therefore be removed from the accumulator chamber from time to time.

### BRIEF SUMMARY OF THE INVENTION

The invention involves a method for operating a hydropneumatic device for increasing with a working piston and a multiplier piston so as to increase pressure on the working piston, and with an accumulator piston providing for an urgent movement of the working piston by forcing hydraulic fluid out of the accumulator chamber, wherein a ventilation opening is provided in the accumulator chamber, through which air drawn into the accumulator chamber can be discharged during the maintenance process. The core of the invention therefore lies in the fact that for an operating mode in which power strokes are executed, the hydraulic fluid volume in the accumulator chamber is discharged below the ventilation opening in the accumulator chamber. This means that in a conventional operating mode of the hydropneumatic device the ventilation opening is no longer traversed with the accumulation volume, which leads to a reduced entry of air. As a consequence, the interval between maintenance procedures during which the volume of the accumulation chamber is ventilated can be markedly extended, which leads to a more cost-effective operation of the hydropneumatic device.

Preferably during the maintenance procedure, air is discharged from the accumulation chamber until oil escapes from the accumulation chamber via the ventilation opening. As long as the ventilation opening lies at the highest point of the accumulation volume, it is guaranteed that the entire air volume in the accumulation chamber has been eliminated. With the ventilation opening closed, the hydraulic fluid volume in the accumulation chamber is then preferably discharged below the ventilation opening by tracking the accumulator piston.

If in this position the working piston is moved back fully, this ensures that in conventional operation the ventilation opening is no longer reached by the hydraulic fluid volume that has been discharged from the accumulator piston. Preferably, the lowering should continue until in conventional operation a seal on the accumulator piston to the accumulator chamber no longer passes over the ventilation opening. By preventing the ventilation opening from being passed over by means of the seal, the entry of air is reduced.

Furthermore, a core idea of the invention relates to a hydraulic fluid pump for the maintenance of a hydropneumatic device for pressure increase, with a working piston and a multiplier piston for pressure increase on to the working piston and with an accumulator piston for an urgent movement of the working piston by forcing hydraulic fluid out of an accumulator chamber, lies in the fact that the pump is designed to be able to extract a pre-specified volume out of the accumulator chamber.

This permits the process of discharging hydraulic fluid out of the accumulator chamber to be carried out quickly and effectively.

In this context moreover, it is advantageous if the pump is also designed to be able to receive an extracted volume of hydraulic fluid. This makes it unnecessary for an operator to handle different types of equipment and open hydraulic fluid, in order to move hydraulic fluid out of the accumulator chamber to another location.

### BRIEF DESCRIPTION OF THE DRAWINGS

Two exemplary embodiments of the invention are shown in the drawings and are explained in further detail below together with further advantages and characteristics. They show:

FIG. 1, in a schematic cut-away section of a hydropneumatic device for increased pressure, an accumulator piston with mechanical spring tensioning in cross-sectional view, and

FIG. 2, in a comparable illustration, an accumulator piston with “air-spring” loading.

### DETAILED DESCRIPTION OF THE INVENTION

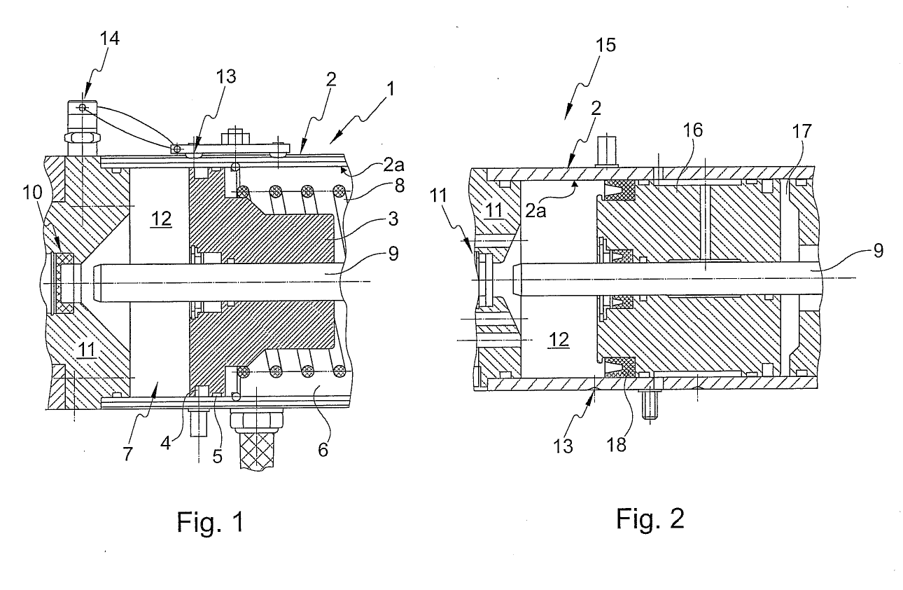

In FIG. 1 a housing section 2 of a hydropneumatic device 1 is shown, in which an accumulator piston 3 moves. The accumulator piston 3 has seals 4, 5 to an inner wall 2a of the housing 2. The seals 4, 5 separate an air region 6 from a region 7, which is filled with hydraulic fluid. The accumulator piston 3 is held via a spring 8 in a permanent state of tension, with which the hydraulic fluid region 7 is correspondingly pressurised.

For an urgent stroke the accumulator piston 3 is moved under the loading of the spring force to a point where (in FIG. 1 moved to the left), the actual power stroke is to take place. Then a multiplier piston 9 is moved through the accumulator piston 3 into a region of the hydraulic fluid volume closed off by a sealing section 10, in order to execute a power stroke with the pre-specified stroke force.

The sealing section 10 is located in a fixed wall 11 mounted on the housing 2. Between the wall 11 and the accumulator piston 3, an accumulator chamber 12 is constructed, which in the optimal case only contains hydraulic fluid.

However, since the entry of air into the accumulator chamber 12 cannot be prevented by the movement of the accumulator piston 3, ventilation of the accumulator chamber 12 is necessary from time to time. This takes place via a ventilation opening 13.

After a known ventilation process, according to the invention the oil volume in the accumulator chamber 12 is from this point on discharged via an oil filling nipple 14 as far as a point at which at least the seal 4, if appropriate also the seal 5, is located behind the ventilation opening 13 viewed in the direction of the accumulator chamber.

For this purpose an oil pump is connected to an oil filling nipple 14.

A filling pump, not shown, is preferably extended to include an additional setback device. The user therefore has the possibility after filling the accumulator chamber 12 until oil escapes from the ventilation opening 13 during a ventilation process, to then switch the pump over to setback mode and thereby again remove a specified quantity of hydraulic oil via the oil filling nipple 14. The quantity of oil necessary for this, which may be different depending on the construction type of a hydropneumatic device 1, is preferably indicated for the user directly on the hydropneumatic device. In addition, e.g., during setback operation, the quantity of oil removed is indicated on the pump using indicating means.

Due to the setting back of the accumulator piston 3 with the setback device, a subsequent traversal of the ventilation opening 13 under appropriate specification of the setback volume is no longer possible.

Due to the elimination of the traversal of the ventilation opening 13, ventilation intervals can be reduced relative to a conventional operating mode.

In FIG. 2, a hydropneumatic device 1 corresponding to the hydropneumatic device 15 of FIG. 1 is illustrated. The difference relative to the hydropneumatic device 1 however consists in the fact that an accumulator piston 16 is not loaded by a spring 8, but is moved by pneumatic pressure in a volume 17. The remaining elements correspond to those of the hydropneumatic device 1 and are therefore in large part designated with the same reference labels.

A seal 18 to the inner wall 2a of the housing section 2 is positioned in FIG. 2 a short distance above the ventilation opening 13, which represents the non-setback condition under the ventilation opening 13 for the accumulator piston 16.

In FIG. 1 the non-setback condition of the accumulator piston 3 is also illustrated.

In order to allow the advantages according to the invention to be exploited, setting back of the oil volume in the accumulator chamber 12 takes place as far as a point at which at least the seal 18 in a maximally extended position of the accumulator piston 16 is still located in front of the ventilation opening 13, viewed in the direction towards the accumulator chamber 12.

Traversal of the ventilation opening 13 by the seal 18 is therefore prevented, which means that no entry of air that could be thereby caused takes place.

What is claimed:

1. A method for operating a hydropneumatic device (1, 15) for pressure multiplication, with a working piston and a multiplier piston (9) for pressure multiplication on to the working piston and with an accumulator piston (3, 16) for an urgent movement of the working piston by forcing hydraulic fluid out of an accumulator chamber (12), wherein a ventilation opening (13) is provided in the accumulator chamber (12), through which air drawn into the accumulator chamber (12) can be discharged during the maintenance process, characterized in that, for an operation in which power strokes are executed, the hydraulic fluid volume in the accumulator chamber (12) is discharged below the ventilation opening (13) in the accumulator chamber.

2. The method according to claim 1, characterized in that, during a maintenance process air is blown out of the accumulator chamber until oil escapes from the accumulator chamber (12) via the ventilation opening (13).

3. The method according to claim 1 or 2, characterized in that, after a ventilation process the hydraulic fluid volume in the accumulator chamber is discharged below the ventilation opening (13).

4. A hydraulic fluid pump for the maintenance of a hydropneumatic device for pressure multiplication, with a working piston and a multiplier piston (9) for pressure multiplication on to the working piston, and with an accumulator piston (3, 16) for an urgent movement of the working piston by forcing hydraulic fluid out of an accumulator chamber (12), characterized in that, the pump is designed to be able to extract a pre-specified volume out of the accumulator chamber (12).

5. The hydraulic fluid pump according to claim 4, characterized in that, the pump is designed to be able to receive an extracted volume of hydraulic fluid.
